(19) United States
(12) Patent Application Publication
(10) Pub. No.: US 2020/0310342 A1
(43) Pub. Date: Oct. 1, 2020

(54) TERMINAL CONNECTION STRUCTURE AND IMAGE FORMING APPARATUS

(71) Applicant: FUJI XEROX CO., LTD., Tokyo (JP)

(72) Inventors: Suguru MATSUNAE, Kanagawa (JP); Yuta HOSHINO, Kanagawa (JP)

(73) Assignee: FUJI XEROX CO., LTD., Tokyo (JP)

(21) Appl. No.: 16/541,724

(22) Filed: Aug. 15, 2019

(30) Foreign Application Priority Data
Mar. 25, 2019 (JP) 2019-057212

(51) Int. Cl. G03G 21/16; H01R 13/24

(52) U.S. Cl. CPC G03G 21/1652; H01R 13/2421

(57) ABSTRACT

A terminal connection structure between a first device to be detachably attached for use and a second device having a mounting section to which the first device is to be detachably attached includes: at least one connection terminal provided in the first device; and at least one connection target terminal that is provided in the second device and comes into contact with the connection terminal in an electrically conductive manner when the first device is attached to the mounting section, one of the connection terminal and the connection target terminal having a structure including a plurality of contact portions to be in contact with the other.

### CROSS-REFERENCE TO RELATED APPLICATIONS

This application is based on and claims priority under 35 USC 119 from Japanese Patent Application No. 2019-057212 filed Mar. 25, 2019.

### BACKGROUND

### (i) Technical Field

The present disclosure relates to a terminal connection structure and an image forming apparatus.

### (ii) Related Art

In the related art, as a technology related to a terminal connection structure used in an image forming apparatus, those described in the following JP-A-2010-020219, JP-A-2011-107645, and JP-A-2017-120351 are known.

JP-A-2010-020219 describes a technology including electrode terminals provided on a substrate of a substrate member on which a storage element is installed, in which any of the electrode terminals is formed as four elongated fiat plate-shaped terminals that are arranged in parallel to a connection direction between a toner cartridge detachably attached to an image forming station of an image forming apparatus and the image forming apparatus having an electrode terminal of a connected portion electrically connected to the electrode terminal when the toner cartridge is attached to the image forming station.

JP-A-2011-107645 describes a technology including: a first protection connection terminal that can come into contact with a connection terminal between an attachable and detachable unit that has the connection terminal of a storage medium and is detachably attached to an image forming apparatus main body and the image forming apparatus that has a connection target terminal which comes into contact with and is connected to the connection terminal when the attachable and detachable unit is attached to the image forming apparatus main body; a second protection connection terminal that is electrically connected to the first protection connection terminal and can come into contact with the connection target terminal; and a protection member that has a protection member main body that supports the first protection connection terminal and the second protection connection terminal and is supported by the attachable and detachable unit in a state where the first protection connection terminal is connected to the connection terminal, and in which, in a case of being attached to the image forming apparatus main body, the second protection connection terminal is connected to the connection target terminal.

JP-A-2017-120351 describes a technology including a guide member that moves a first terminal in a direction perpendicular to a contact surface of the first terminal that is in contact with a second terminal, that is, in a direction of gradually approaching the second terminal until reaching an insertion completion position in an insertion direction when a consumable container is inserted into an accommodating section of an apparatus main body between the consumable container, such as a toner cartridge that has the first terminal of a storage member and is detachably attached to the accommodating section of the apparatus main body of an image forming apparatus and the image forming apparatus that has the second terminal which comes into contact with and is connected to the first terminal when the consumable container is mounted in the accommodating section of the apparatus main body. Regarding the first terminal, an example in which a center portion in a front-rear direction is formed by a U-shaped or V-shaped plate spring that projects to a lower side, is illustrated.

### SUMMARY

Aspects of non-limiting embodiments of the present disclosure relate to providing a terminal connection structure in which abnormal contact is less likely to occur between a connection terminal and a connection target terminal connected in an electrically conductive manner than in a structure where a connection terminal and a connection target terminal are brought into contact with each other at one point and to providing an image forming apparatus using such a terminal connection structure.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a terminal connection structure between a first device to be detachably attached for use and a second device having a mounting section to which the first device is to be detachably attached, the terminal connection structure including: at least one connection terminal provided in the first device; and at least one connection target terminal that is provided in the second device and comes into contact with the connection terminal in an electrically conductive manner when the first device is attached to the mounting section, one of the connection terminal and the connection target terminal having a structure including plural contact portions to be in contact with the other.

### BRIEF DESCRIPTION OF THE DRAWINGS

Exemplary embodiments of the present invention will be described in detail based on the following figures, wherein:

FIG. 1 is a schematic view illustrating a configuration of an image forming apparatus according to Exemplary Embodiment 1;

FIG. 2 is a schematic perspective view illustrating a configuration of a developer storage container and a replenishing unit in the image forming apparatus of FIG. 1;

FIG. 3 is a schematic perspective view illustrating a part of the developer storage container and the replenishing unit of FIG. 2 in an enlarged manner;

FIG. 4 is a schematic perspective view illustrating a state of a connection terminal in the developer storage container;

FIG. 5 is a schematic perspective view illustrating a state of a connection target terminal in a connector unit provided in the image forming apparatus;

FIG. 6 is a schematic view illustrating a connection state of the connection terminal in the developer storage container and the connection target terminal in the connector unit;

FIGS. 7A and 7B are schematic views illustrating a configuration of the connection target terminal provided with plural contact portions;

FIGS. 8A to 8C are schematic views illustrating a configuration and a contact state of the connection target terminal provided with the plural contact portions;

FIG. 9 is a schematic view illustrating a connection state in a terminal connection structure according to Exemplary Embodiment 1 in an enlarged manner;

FIG. 10 is a schematic view illustrating a connection state in a terminal connection structure according to Exemplary Embodiment 2 in an enlarged manner;

FIGS. 11A to 11C are schematic views illustrating a configuration and a contact state of the connection target terminal provided with the plural contact portions in the connection structure of FIG. 10;

FIG. 12 is a schematic view illustrating a connection state in a terminal connection structure according to Exemplary Embodiment 3 in an enlarged manner; and

FIGS. 13A to 13C are schematic views illustrating a configuration and a contact state of the connection target terminal provided with the plural contact portions in the connection structure of FIG. 12.

### DETAILED DESCRIPTION

Hereinafter, exemplary embodiments of the disclosure will be described with reference to the drawings.

### Exemplary Embodiment 1

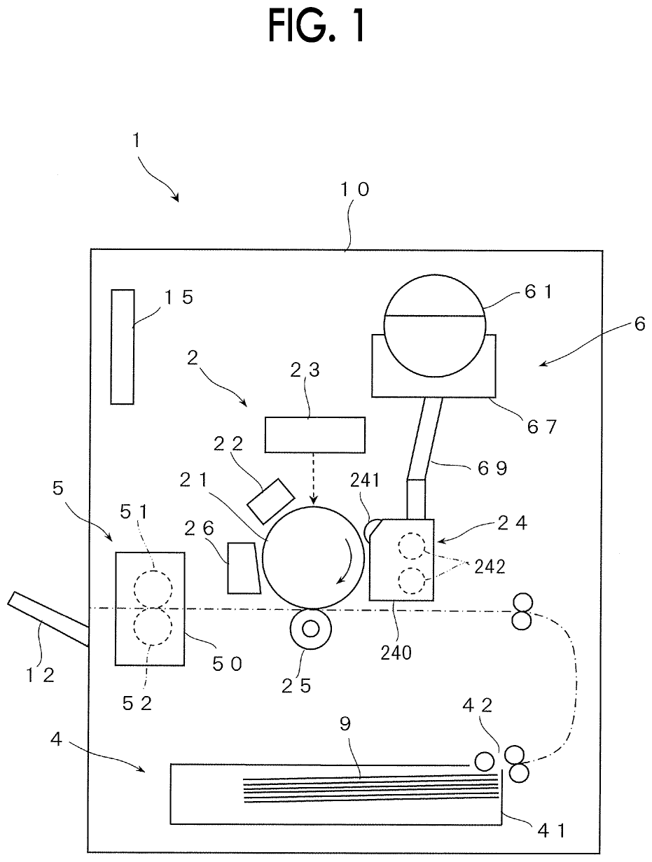

FIG. 1 conceptually illustrates a configuration of an image forming apparatus using a terminal connection structure according to Exemplary Embodiment 1.

Image Forming Apparatus

An image forming apparatus 1 is an apparatus that forms an image formed by toner as a developer on paper 9 which is an example of a recording medium by using an image forming method, such as an electrophotographic method. The image forming apparatus 1 is configured, for example, as a printer that forms an image that corresponds to image information, such as characters, figures, tables, and photographs input from an external device, such as an information terminal or an image reading device.

As illustrated in FIG. 1, the image forming apparatus 1 includes: an image forming unit 2 that forms a toner image by an image forming method, such as an electrophotographic method, and transfers the toner image to the paper 9, in an internal space of a housing 10 which is an example of an apparatus main body; a paper feeding unit 4 that accommodates and feeds the paper 9 fed to the image forming unit 2; a fixing unit 5 that fixes the toner image transferred by the image forming unit 2 to the paper 9; and a replenishing unit 6 that replenishes a developer to a developing machine 24 in the image forming unit 2. One-dot chain line illustrated in FIG. 1 is a main transport path along which the paper 9 is transported in the internal space of the housing 10. Further, a reference numeral 15 in FIG. 1 indicates a control unit that controls each operation in the image forming apparatus 1.

The image forming unit 2 has a photosensitive drum 21 which is an example of a photosensitive body that rotates in a direction indicated by the arrow, and around the photosensitive drum 21, a charging device 22 that charges an image forming region on a peripheral surface of the photosensitive drum 21 with a required potential; an exposure device 23 that exposes the charged image forming region of the photosensitive drum 21 based on image information to form an electrostatic latent image; a developing machine 24 that develops the electrostatic latent image formed on the photosensitive drum 21 with the developer and makes the electrostatic latent image into a toner image; a transfer device 25 that transfers the toner image formed on the photosensitive drum 21 onto the paper 9; and a cleaning device 26 that cleans the image forming region of the photosensitive drum 21, are disposed.

Among the members, as illustrated in FIG. 1, on the inside of the housing 240 having a storage chamber for accommodating the developer and a development opening for performing the development, the developing machine 24 includes: a developing roll 241 that holds and transports the developer to cause the developer to pass through a developing area that faces the photosensitive drum 21; and a transporting unit 242 that transports the developing roll to cause the developer to pass while stirring the developer in the storage chamber. As a developer, for example, a two-component developer including a toner and a carrier is used.

In addition, in the developing machine 24, since the developer in a housing 240 is consumed by the development and reduced, the developer is replenished from the replenishing unit 6.

The paper feeding unit 4 includes: a container 41 (not illustrated) that accommodates the paper 9 having a desired size, type, and so on in a stacked state; and a feeding device 42 that feeds the paper 9 from the container 41 one by one toward a transfer unit in the image forming unit 2. The paper 9 may be a recording medium that can be transported in the image forming apparatus 1 and can transfer and fix the toner image.

The fixing unit 5 includes: a heating roller 51 having a roll form, a belt-nip form, or the like, which rotates while being heated, and a pressing roller 52 having a roll form, a belt-nip form, or the like, which is in contact with the heating roller 51 at a required pressure to form a fixing nip, in a housing 50 provided with an introduction port and an output port (which are not illustrated) of the paper 9.

In addition, in the image forming apparatus 1, when receiving command information of a request to form an image, first, in the image forming unit 2, known processes (processes of charging, exposure, development, and transfer) in an image forming method, such as an electrophotographic method, are executed.

In other words, in the image forming unit 2, a toner image that corresponds to the image information is formed on the photosensitive drum 1, and thereafter, the toner image is transferred onto one side of the paper 9 supplied from the paper feeding unit 4. The photosensitive drum 21 after the transfer is cleaned by the cleaning device 26.

Subsequently, the paper 9 that holds the toner image transferred by the image forming unit 2 is introduced into the fixing nip in the fixing unit 5, and the toner image is fixed onto the paper 9 by fixing processing (heating and pressing) when the paper 9 passes through the fixing nip.

The paper 9 on which fixing has been completed is transported and stored, for example, in a discharging and accommodating section 12 provided on the outside of the housing 10. Accordingly, the image forming operation on one side of the paper 9 by the image forming apparatus 1 is completed.

Next, as illustrated in FIG. 1, the replenishing unit 6 includes: a developer storage container 61 that stores the developer to be replenished; a replenishment drive device 67 that feeds the developer that is in the developer storage container 61 to be replenished at the required time and by the required amount with respect to the developing machine 24; and a transport pipe 69 that transports the developer fed from the replenishment drive device 67 to the developing machine 24.

The developer storage container 61 is detachably attached to a mounting section (not illustrated) of the housing 10 and used, and is configured as an example of an attaching and detaching unit.

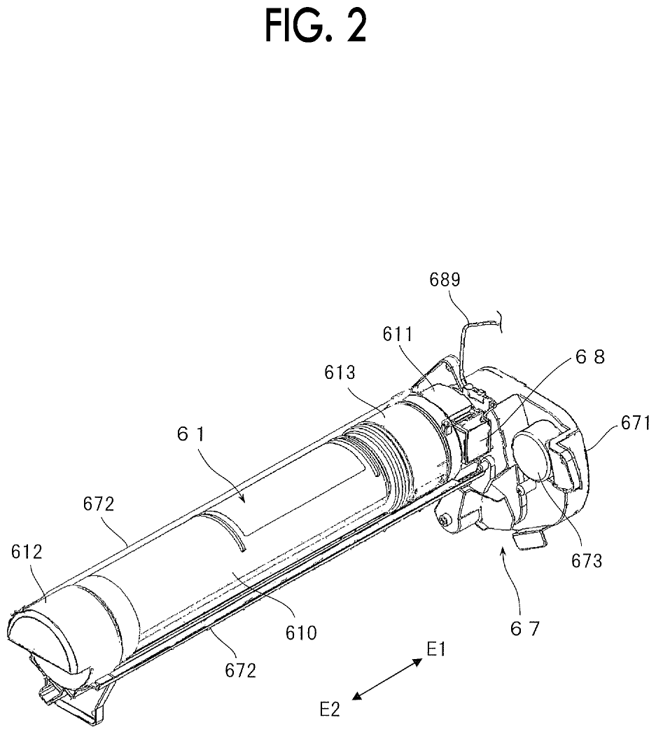

Further, as illustrated in FIG. 2 and other drawings, the developer storage container 61 includes: a cylindrical container main body 610 in which the developer for replenishment is stored; a far end portion structure 611 attached to an end portion that is on a far side when mounting the container main body 610; and a near end portion structure 612 attached to an end portion on a near side when mounting the container main body 610. The developer for replenishment is, for example, a toner alone or a toner containing a small amount of carrier. Further, the arrow indicated by a reference numeral E1 in FIG. 2 and other drawings indicates a pushing direction which is a moving direction when mounting the developer storage container 61, and the arrow indicated by a reference numeral E2 indicates a pulling direction which is a moving direction when removing the developer storage container 61.

In the end portion on the far side of the container main body 610, an output structure portion 613 having the output port (not illustrated) for outputting the developer from the container main body 610 and an open and close shutter (not illustrated) for opening and closing the output port, is formed. In addition, on the inside of the container main body 610, the transporting unit, such as an agitator (not illustrated) that rotates and transports the developer so as to move the developer toward the output port in the output structure portion 613 at the time of replenishment, is disposed.

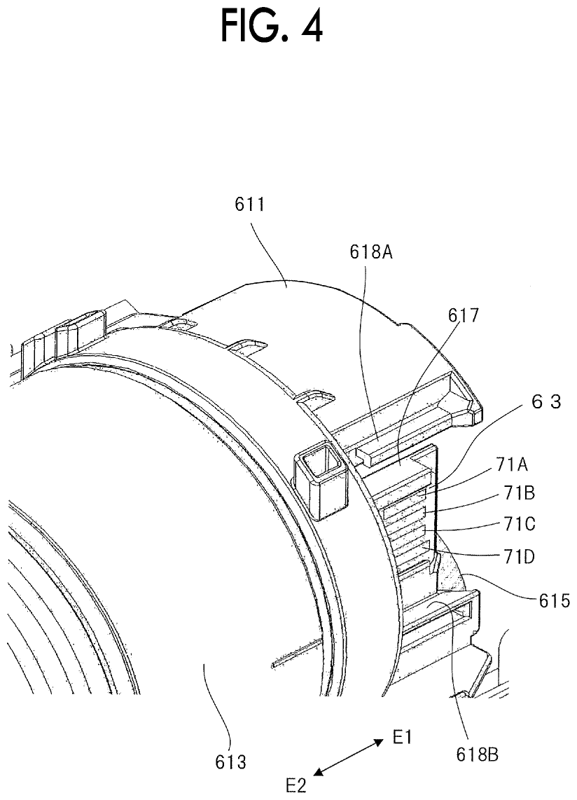

The far end portion structure 611 has a structure that closes the end portion on the rear side of the container main body 610 and supports a rotating shaft of the transporting unit in a cantilever state. In addition, in the end portion structure 611, a drive connecting member 615 (FIG. 4), such as a coupling for transmitting the rotational power of a rotational drive device (drive motor 673: FIG. 2) in the replenishment drive device 67 to the transporting unit, is disposed in a state of being exposed to the outside.

Meanwhile, the near end portion structure 612 has a structure that closes the end portion on the far side of the container main body 610 and has a function as a handle for holding the developer storage container 61 by hand at the time of attaching and detaching work.

In addition, the developer storage container 61 includes an accommodating section 617 that accommodates a storage medium 63 in which intrinsic information of the developer storage container 61 is stored in one side surface portion of the far end portion structure 611.

Here, the intrinsic information is, for example, information, such as the product number of the developer storage container 61, the type or storage amount of the developer, and the usage history. In addition, as the storage medium 63, for example, a storage medium, such as a customer replaceable unit memory (CRUM), is used.

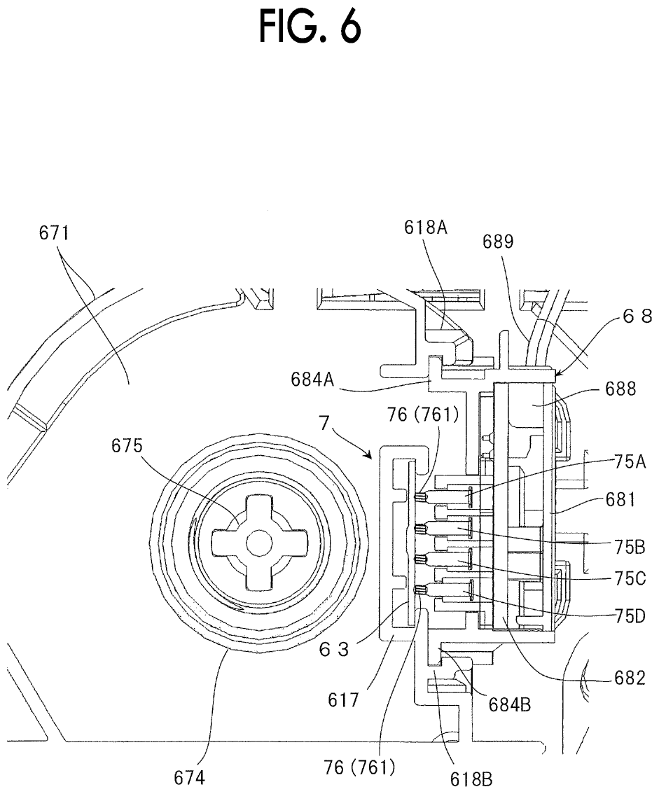

As illustrated in FIG. 4, FIG. 6 and other drawings, the storage medium 63 accommodated in the accommodating section 617 is a medium in the form of a plate in which a memory element or the like is incorporated, and plural (four in the example) connection terminals 71A, 71B, 71C, and 71D are provided on the side surface thereof.

As illustrated in FIG. 6 and other drawings, the accommodating section 617 has a structure that holds several necessary places (for example, two places on the other surface and the left and right end portions on one surface) in a state of being sandwiched on both surfaces of the storage medium 63 except for the part at which the connection terminals 71A, 71B, 71C, and 71D are present. In addition, as illustrated in FIG. 4, FIG. 6 and other drawings, when the accommodating section 617 faces and is connected to a connector unit (68) (described later) which is a connection target, one pair of upper and lower guide target portions 618A and 618B that are respectively guided by one pair of upper and lower guide portions (684A and 684B) in the connector unit (68) is provided.

The replenishment drive device 67 includes: a housing 671 that is also an apparatus main body; and a container holding section 672 that is disposed integrally with one side of the housing 671 and holds the developer storage container 61. Among the members, the container holding section 672 forms a part of the mounting section to which the developer storage container 61 is attached.

In the housing 671, an accommodation and transport section (not illustrated) that temporarily accommodates the developer output from the developer storage container 61 and feeds a necessary amount of developer in the transport pipe 69; a feeding member (not illustrated) that is driven to feed the developer accommodated in the accommodation and transport section to the transport pipe 69; and a drive transmission mechanism (not illustrated) that transmits the rotational power, are disposed.

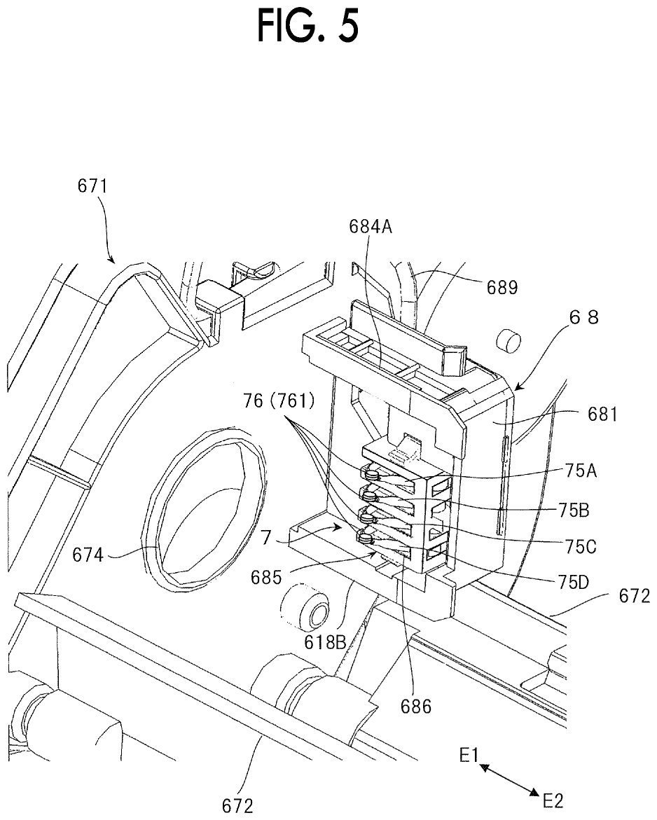

Further, an electric motor 673 is attached to the housing 671. The rotational power of the electric motor 673 is transmitted to the feeding member that is in the housing 671 or the developer storage container 61 held by the container holding section 672, via the drive transmission mechanism (not illustrated). Further, as illustrated in FIG. 5 or 6, the housing 671 is provided with an opening hole 674 for allowing the drive connecting member 615 in the developer storage container 61 to pass at the side surface part that faces the container holding section 672, and a drive connecting member 675, such as a coupling that is connected to the drive connecting member 615 and transmits the rotational power is disposed on the inside on the far side through which the opening hole 674 passes.

The container holding section 672 is formed to have a structure that holds a part on the lower portion side along the longitudinal direction of the developer storage container 61. In addition, in the container holding section 672, at the end portion that faces the housing 671, a connection passage (not illustrated) for sending the developer output from the output port of the developer storage container 61 to the accommodation and transport section of the housing 671.

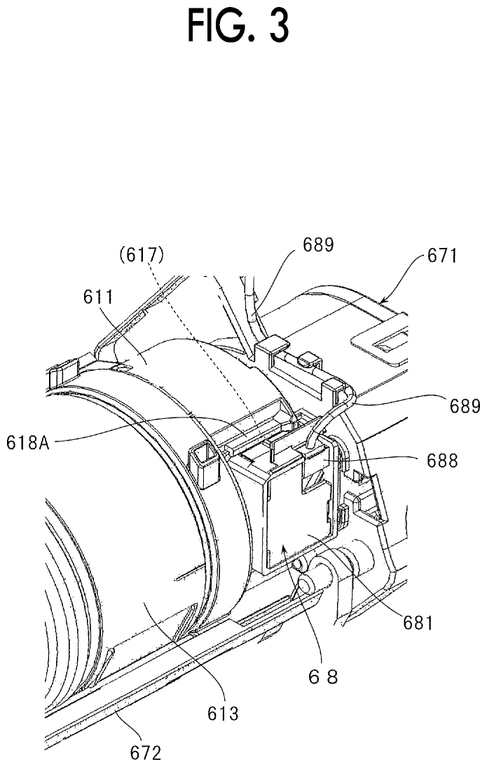

In addition, as illustrated in FIG. 2, FIG. 3, FIG. 5, and other drawings, the replenishment drive device 67 is provided with a connector unit 68 for electric connection to the storage medium 63 in the accommodating section 617 of the developer storage container 61 located close to part thereof.

The connector unit 68 is disposed on the housing 10 side of the image forming apparatus 1. Further, the connector unit 68 has a substantially rectangular box-shaped support frame 681 and located to extend from the housing 671 to an end portion on one side of the container holding section 672 so that it can face the accommodating section 617 of the developer storage container 61. As illustrated in FIG. 5, FIG. 6 and other drawings, the support frame 681 of the connector unit 68 has a pair of upper and lower guide portions 684A and 684B that respectively guide the pair of upper and lower guide target portions 618A and 618B in the accommodating section 617 when facing and connected to the accommodating section 617 as the connection target during the attachment of the developer storage container 61.

In addition, the connector unit 68 has, at a site on the side facing the developer storage container 61 of the support frame 681, plural (four in the example) connection target terminals 75A, 75B, 75C, and 75D that respectively come into contact with connection terminals 71A, 71B, 71C, and 71D of the storage medium 63 in the accommodating section 617 of the developer storage container 61 so that they are connected in an electrically conductive manner.

The connection target terminals 75A, 75B, 75C, and 75D are integrated into a harness connector 688 through a circuit board 682 disposed inside the support frame 681 and then connected to a cable harness 689 through the harness connector 688. The cable harness 689 is connected to the control unit 15 in the image forming apparatus 1.

As illustrated in FIG. 1, the transport pipe 69 is disposed to connect the replenishment drive device 67 and the developing machine 24 to each other. The transport pipe 69 includes a transport pipe of a system in which the developer fed from the replenishment drive device 67 is dropped naturally and transported, or a transport pipe of a system in which the developer is transported by the transporting unit for driving.

In the replenishing unit 6, as illustrated in FIG. 2, when the developer storage container 61 is mounted and held by the container holding section 672, the drive connecting member 615 of the developer storage container 61 is in a state of being coupled with the drive connecting member 675 in the replenishment drive device 67. At this time, in the replenishing unit 6, as illustrated in FIG. 6, the connection terminals 71 A, 71B, 71C, and 71D of the storage medium 63 in the accommodating section 617 of the developer storage container 61 is in a state of being in contact with the connection target terminals 75A, 75B, 75C, and 75D of the connector unit 68 in the replenishment drive device 67 in an electrically conductive manner, that is, in a state of being electrically connected.

Accordingly, the transporting unit in the developer storage container 61 is in a state where the rotational power from the replenishment drive device 67 is transmitted to be in a drivable state. In addition, the control unit 15 of the image forming apparatus 1 can communicate with the storage medium 63 of the developer storage container 61 via the cable harness 689, and is in a state of being capable of reading and writing information.

In addition, in the replenishing unit 6, the replenishment drive device 67 is driven at a necessary time in accordance with the information, such as the consumption amount of the developer (actually, toner) in the developing machine 24, predicted by the control unit 15.

Accordingly, the replenishing unit 6 feeds the developer in the developer storage container 61 by a required amount, and transports the developer through the transport pipe 69 to the developing machine 24 for replenishment. The replenished developer is input into the storage chamber in the housing 240 of the developing machine 24.

Terminal Connection Structure

In addition, the image forming apparatus 1 uses a terminal connection structure 7 formed as described below between the connection terminals 71A, 71B, 71C, and 71D in the storage medium 63 of the developer storage container 61 and the connection target terminals 75A, 75B, 75C, and 75D of the connector unit 68 in the replenishment drive device 67.

As illustrated in FIG. 4 and other drawings, the connection terminals 71A, 71B, 71C, and 71D in the storage medium 63 are formed by disposing metallic plates of an elongated rectangular shape in parallel in a direction along directions E1 and E2 in which the developer storage container 61 is moved for attachment and detachment. In addition, the surface of the connection terminals 71A, 71B, 71C, and 71D may be plated with metal, such as gold.

Meanwhile, as illustrated in FIG. 5 and other drawings, the connection target terminals 75A, 75B, 75C, and 75D of the connector unit 68 each form a structure capable of intruding to a site on the side of the support frame 681 facing the storage medium 63 of the developer storage container 61. In such an intruding structure, the connection target terminals 75A, 75B, 75C, and 75D are each provided to be elastically deformable and displaceable to a position matching the the position of each of the connection terminals 71A, 71B, 71C, and 71D when brought into contact with the connection terminals 71A, 71B, 71C, and 71D.

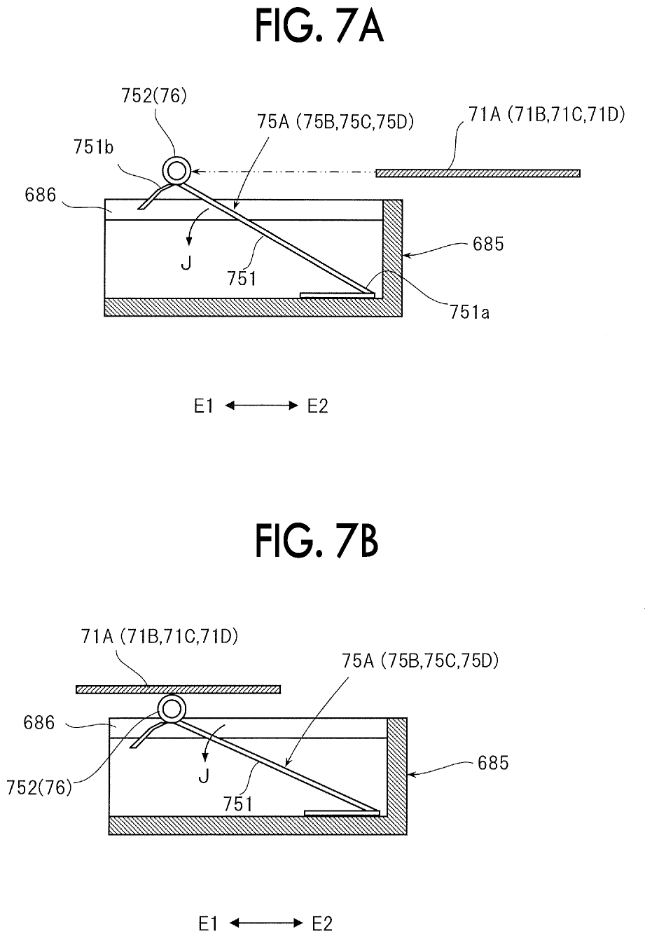

As illustrated in FIG. 5, FIGS. 7A and 7B and other drawings, the connection target terminals 75A, 75B, 75C, and 75D in Exemplary Embodiment 1 are attached to a box-shaped terminal attachment base 685 having four cutout portions 686 formed to extend in the direction along the directions E1 and E2 in which the developer storage container 61 is moved for attachment and detachment.

As illustrated in FIG. 7A and other drawings, the connection target terminals 75A, 75B, 75C, and 75D each includes: a flat spring-shaped support portion 751 having one end portion fixed to a bottom portion of the terminal attachment base 685 and having another end portion inclined and extending to project to outside through the cutout portion 686; and a contact portion 752 provided on the other end portion of the support portion to actually come into contact with the connection terminal 71A, 71B, 71C, or 71D.

As illustrated in FIG. 7A and other drawings, the support portion 751 is disposed such that one end portion to he fixed is positioned upstream in the direction E1 where the developer storage container 61 is moved for attachment, and is disposed such that the other end portion on which the contact portion 752 is provided is positioned downstream in the moving direction E1. In addition, the parts from the one end portion to the other end portion of the support portion 751 are held in a state of being inclined to he in a state of respectively approaching the connection terminals 71A, 71B, 71C, and 71D to be brought into contact as approaching the downstream side in the moving direction E1 when mounting the developer storage container 61. Furthermore, the other end portion of the support portion 751 is electrically connected to a circuit board or the like (not illustrated) in the support frame 681.

The support portion 751 is elastically deformed in a direction (intruding direction) indicated by an arrow J so as to be displaced to a position that corresponds to the position of the connection terminal 71A or the like, as illustrated in FIG. 7B, when the connection terminal 71A or the like in the storage medium 63 come into contact with the contact portion 752 when mounting the developer storage container 61.

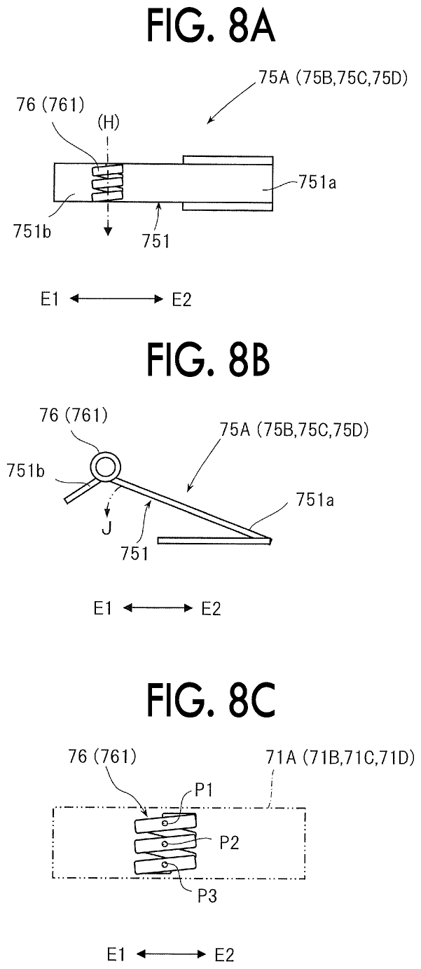

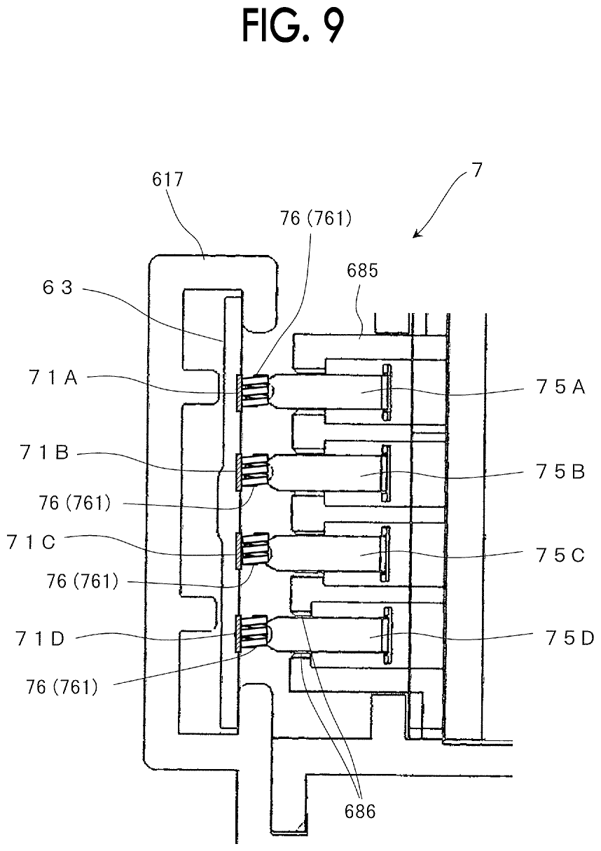

In addition, in the terminal connection structure 7, as illustrated in FIGS. 8A to 8C, FIG. 9 and other drawings, the contact portion 752 in the connection target terminals 75A, 75B, 75C, and 75D, has a configuration with a structure having plural contact portions 76 that individually respectively come into contact with the connection terminals 71A, 71B, 71C, and 71D one by one at plural places.

As illustrated in FIGS. 8A to 8C and other drawings, a conductive coil spring 761 is used to form plural contact portions 76 in the Exemplary Embodiment 1.

The coil spring 761 may be a spring that is formed by spirally winding plural times a wire made of an elastically deformable metal and at least having a conductive surface. The conditions, such as the number of turns of the coil spring 761, the diameter of the turn, or the thickness of the wire, are set to any condition in accordance with the relationship between the terminals connected to each other, or the like. In addition, the coil spring 761 used may be a compression spring having plural contact portions 76 which are adjacent parts of a wire and separated from each other. Alternatively, the coil spring 761 used may be, for example, an extension spring having adjacent parts of a wire in contact with each other as long as it provides plural contacts independent from each other.

In addition, as illustrated in FIG. 8A, the coil spring 761 that forms plural contact portions 76 is disposed such that its height direction H is oriented substantially orthogonal to the directions E1 and E2 in which the developer storage container 61 is moved for attachment and detachment. Accordingly, the wire of the coil spring 761 is oriented in a direction substantially along the moving directions E1 and E2 of the developer storage container 61.

Connection State by Terminal Connection Structure

In the image forming apparatus 1 using the terminal connection structure 7, when the developer storage container 61 is attached to the mounting section of the housing 10, the connection terminals 71A, 71B, 71C, and 71D in the storage medium 63 of the developer storage container 61 and the connection target terminals 75A, 75B, 75C, and 75D of the connector unit 68 in the replenishment drive device 67 are connected to each other as follows.

First, the developer storage container 61 is moved in the pushing direction indicated by the arrow E1 while being held by the container holding section 672 of the replenishing unit 6 when mounting the developer storage container 61.

At this time, when the accommodating section 617 in the developer storage container 61 is on the stage of starting to approach and face the connector unit 68 in the replenishment drive device 67, as illustrated in FIG. 6 and other drawings, the accommodating section 617 becomes to advance to be in a state where the pair of upper and lower guide target portions 618A and 618B are introduced into and guided by the pair of upper and lower guide portions 684A and 684B in the connector unit 68.

In the process in which the accommodating section 617 advances while facing the connector unit 68, the four connection terminals 71A, 71B, 71C, and 71D in the storage medium 63 in the accommodating section 617 advance to be in a state of being in contact with (the contact portion 752 of the connection target terminals 75A, 75B, 75C, and 75D in the connector unit 68.

At this time, in the connection target terminals 75A, 75B, 75C, and 75D having an intruding structure, as illustrated in FIG. 7B, the other end portions 751b side of each support portion 751 are in a state of being elastically deformed and displaced so as to intrude inward from the cutout portion 686 of the terminal attachment base 685 to the positions aligned with the positions of the connection terminals 71A, 71B, 71C, and 71D.

Subsequently, when the developer storage container 61 is pushed to a mounting position (FIG. 2), the mounting of the developer storage container 61 is completed.

When the mounting of the developer storage container 61 is completed, as illustrated in FIG. 6, the four connection terminals 71A, 71B, 71C, and 71D which are in the storage medium 63 in the accommodating section 617 are in a state of individually being in contact with and connected to the connection target terminals 75A, 75B, 75C, and 75D in the connector unit 68.

When the connection state at this time is viewed from the connection target terminals 75A, 75B, 75C, and 75D, as illustrated in FIG. 9 and other drawings, the connection target terminals 75A, 75B, 75C, and 75D are in a state where the plural contact portions 76 including the coil spring 761 respectively come into contact with and are connected to the connection terminals 71A, 71B, 71C, and 71D. In other words, as illustrated in FIG. 8C or 9, the connection target terminals 75A, 75B, 75C, and 75D at this time are in a state of being in contact with each of the connection terminals 71A, 719, 71C, and 71D at plural places by the plural contact portions 76.

In Exemplary Embodiment 1, as illustrated in FIG. 7B or FIG. 8C, the parts of the wire of the coil spring 761, which form the plural contact portions 76 facing the connection terminal 71A, 71B, 71C, or 71D, come into contact with each of the connection terminals 71A, 719, 71C, and 71D,

The contact parts of the coil spring 761 for the plural contact portions 76 are, for example, three rounded portions P1, P2 and P3, as illustrated in FIG. 8C in an enlarged manner, which provide contact points. In addition, the plural contact portions 76 come into contact with each of the four connection terminals 71A, 71B, 71C, and 71D at the three portions P1, P2, and P3, which are arranged in a direction substantially orthogonal to the moving directions E1 and E2 during attachment of the developer storage container 61.

In the terminal connection structure 7 used for connection, therefore, each of the four connection terminals 71A, 71B, 71C, and 71D in the storage medium 63 comes into contact with each of the connection target terminals 75A, 75B, 75C, and 75D in the connector unit 68 at the plural contact portions 76, so that abnormal contact is less likely to occur and good connection is achieved between them. In addition, this connection allows reliable contact of at least one of the plural contact portions 76 even when fine foreign matter, such as toner or dust, exists on at least one of the connection terminals 71A, 71B, 71C, and 71D and the connection target terminals 75A, 75B, 75C, and 75D or they are worn off at some points, so that abnormal contact is prevented.

In this regard, in a case where the connection terminals 71A, 71B, 71C, and 71D and the connection target terminals 75A, 75B, 75C, and 75D come into contact with each other at one point at the part at which the terminals are in contact with each other, when at least one of the terminals has the above-described fine foreign matter or the part that is worn exists, abnormal contact is more likely to occur.

Meanwhile, in a case where the terminal connection structure 7 according to Exemplary Embodiment 1 is used, abnormal contact is prevented as described above.

As a result, in the image forming apparatus 1 using the terminal connection structure 7, communication of information between the developer storage container 61 and the control unit 15 is excellently secured when the developer storage container 61 is attached, so that communication failure is less likely to occur.

In addition, in the terminal connection structure 7 according to Exemplary Embodiment 1, the plural contact portions 76 is formed of the coil spring 761, which makes it easy to form the plural contact portions 76. In addition, the circular arc-shaped portions to be in contact with the terminals can soften and reduce the impact at the time of contact with the connection terminals 71A, 71B, 71C, and 71D. Furthermore, since the elastic deformation due to the spring can be obtained, it is likely to make a state of being in contact to be slightly displaced in the up-down and left-right directions in accordance with the situation when the wire of the coil spring 761 comes into contact with the terminal.

In addition, in the connection structure 7, since the coil springs 761 of the plural contact portions 76 are disposed such that the height direction H is the direction substantially orthogonal to the moving directions E1 and E2 when attaching and detaching the developer storage container 61, the parts that are in contact are in a state of being arranged in the direction substantially orthogonal to the moving directions E1 and E2 (FIG. 8C). Therefore, compared to a case where the coil spring 761 is not disposed to face the above-described direction, a case where the plural contact portions 76 are prevented from being hooked when coming into contact with the connection terminals 71A, 71B, 71C, and 71D or prevented from causing useless frictional resistance, and there is no concern that a failure of attaching and detaching work of the developer storage container 61 occurs.

Furthermore, in the connection structure 7, since the plural contact portions 76 are provided on the connection terminals 75A, 75B, 75C, and 75D of the intruding structure, compared to a case where the contact portions 76 are not provided on the terminals in the intruding structure, the impact at the time of contact with the plural contact portions 76 is reduced, the contact at the plural contact points is excellently maintained, and accordingly, the abnormal contact is prevented.

### Exemplary Embodiment 2

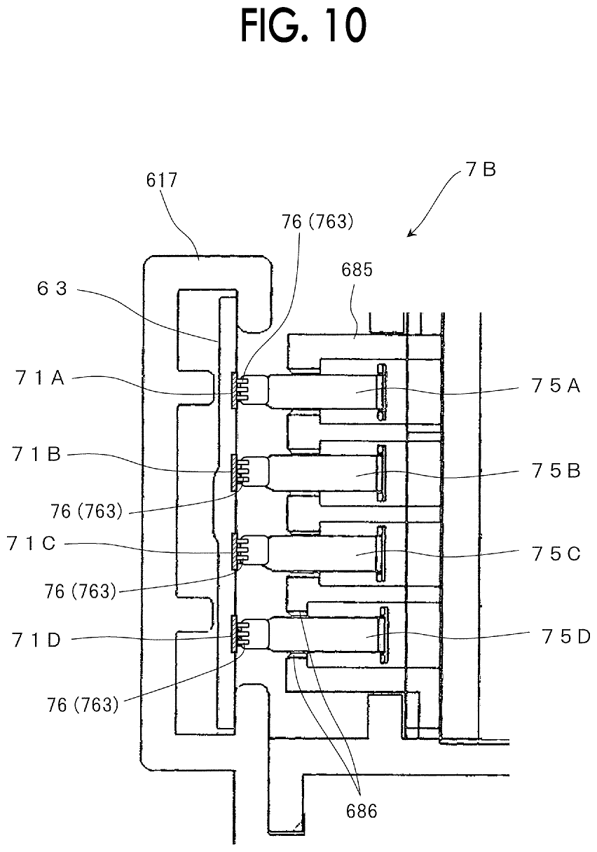

FIG. 10 illustrates a terminal connection structure 7B according to Exemplary Embodiment 2.

The terminal connection structure 7B according to Exemplary Embodiment 2 is a structure having the same configuration as that of the terminal connection structure 7 according to Exemplary Embodiment 1 except that plural wire parts are disposed side by side instead of the coil springs 761 for the plural contact portions 76.

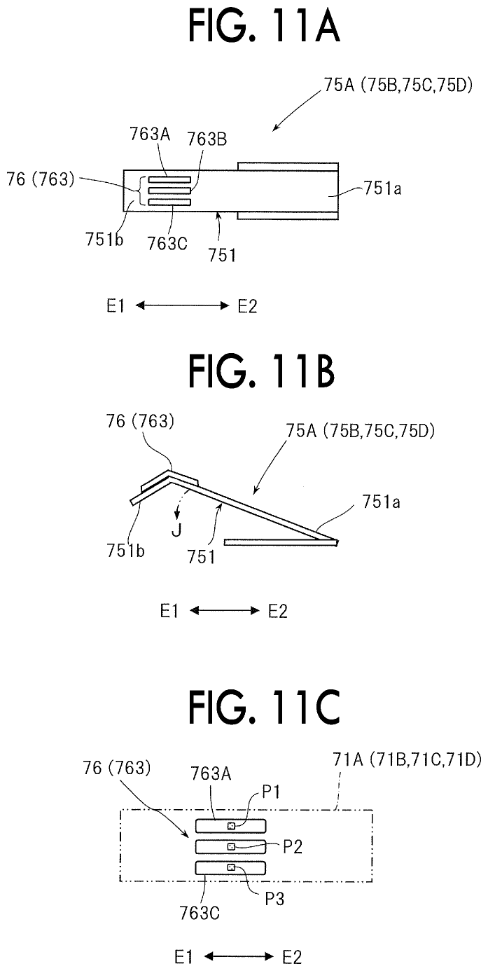

As illustrated in FIG. 10 or 11A to 11C, the terminal connection structure 7B includes plural (three in the example) wire parts 763A, 763B, and 763C disposed side by side to form plural contact portions 76. The wire parts 763A, 763B, and 763C are made of a material at least having a conductive surface. In addition, the conditions, such as the sectional shape, the thickness, the length or the like of the wire parts 763A, 763B, and 763C, are set to any condition in accordance with the relationship between the terminals connected to each other, or the like.

In addition, as illustrated in FIG. 11A, the wire parts 763A, 763B, and 763C that form the plural contact portions 76 are disposed such that the length (longitudinal) direction thereof is in a state of facing in a direction substantially along the moving directions E1 and E2 when attaching and detaching the developer storage container 61. Accordingly, the wire parts 763A, 763B, and 763C are in a state of being arranged in parallel at intervals from each other in a state of being oriented in the direction substantially along the moving directions E1 and E2 of the developer storage container 61.

Furthermore, the three wire parts 763A, 763B, and 763C are disposed in a state of being bent in a chevron shape as illustrated in FIG. 11B.

In addition, in the image forming apparatus 1 using the terminal connection structure 7B, when the mounting of the developer storage container 61 is completed as described in Exemplary Embodiment 1, as illustrated in FIG. 10, the four connection terminals 71A, 71B, 71C, and 71D that are in the storage medium 63 in the accommodating section 617 of the developer storage container 61 are in a state of individually being in contact with and connected to the connection target terminals 75A, 75B, 75C, and 75D in the connector unit 68 that is in the replenishment drive device 67.

When the connection state at this time is viewed from the connection target terminals 75A, 75B, 75C, and 75D, as illustrated in FIG. 10 and other drawings, the connection target terminals 75A, 75B, 75C, and 75D are in a state where the plural contact portions 76 formed by arranging the three wire parts 763A, 763B, and 763C respectively come into contact with and are connected to the connection terminals 71A, 71B, 71C, and 71D.

In other words, in the connection target terminals 75A, 75B, 75C, and 75D at this time, as illustrated in FIG. 10 or 11C, the parts of the wire which is on the side that faces the connection terminals 71A, 71B, 71C, and 71D of the three wire parts 763A, 763B, and 763C that form the plural contact portions 76 respectively come into contact with the connection terminals 71A, 71B, 71C, and 71D.

The contact parts of the wire parts 763A, 763B, and 763C at this time are, for example, contact points including the three rounded parts P1, P2, and P3, as illustrated in FIG. 11C in an enlarged manner. In addition, the plural contact portions 76 at this time also come into contact with each of the four connection terminals 71A, 71B, 71C, and 71D at the three parts P1, P2, and P3 that are in a state of being arranged in a direction substantially orthogonal to the moving directions E1 and E2 when mounting the developer storage container 61.

In the terminal connection structure 7B used for connection, therefore, each of the four connection terminals 714, 71B, 71C, and 71D in the storage medium 63 comes into contact with and is connected to each of the connection target terminals 75A, 75B, 75C, and 75D in the connector unit 68 at the plural contact portions 76, similar to the case of the terminal connection structure 7 according to Exemplary Embodiment 1, so that abnormal contact is less likely to occur and good connection is achieved between them.

Incidentally, since the plural contact portions 76 are provided on the connection target terminals 75 in (the connector unit 68 of) the mounting section on the housing 10 side of the image forming apparatus 1, compared to a case of being provided on the connection terminal 71 in the developer storage container 61, the number of the plural contact portions 76 may be small and the cost is not increased unnecessarily.

As a result, in the image forming apparatus 1 using the terminal connection structure 7B, communication of information between the developer storage container 61 and the control unit 15 is excellently secured when the developer storage container 61 is attached, similar to the case of the image forming apparatus 1 according to Exemplary Embodiment 1, so that communication failure is less likely to occur.

In addition, in the connection structure 7B, since the three wire parts 763A, 763B, and 763C that form the plural contact portions 76 are disposed so as to be in a state of facing in the direction substantially along the moving directions E1 and E2 when attaching and detaching the developer storage container 61, the parts that are in contact are in a state of being arranged in the direction substantially orthogonal to the moving directions E1 and E2 (FIG. 11C). Therefore, compared to a case where the three wire parts 763A, 763B, and 763C are not disposed to face in the above-described direction, the plural contact portions 76 are prevented from being scratchy or generating useless frictional resistance, and there is no concern about interference to the attaching and detaching of the developer storage container 61.

Furthermore, even in the connection structure 7B, since the plural contact portions 76 are provided on the connection target terminals 75A, 75B, 75C, and 75D of the intruding structure, compared to a case where the contact portions 76 are not provided on the terminals in the intruding structure, the impact at the time of coming into contact with the plural contact portions 76 is reduced, the contact at the plural contact points is excellently maintained, and accordingly, the abnormal contact is prevented.

### Modification Example of Exemplary Embodiment 2

In the terminal connection structure 7B of Exemplary Embodiment 2, instead of disposing the plural wire parts 763A, 763B, and 763C side by side, the plural contact portions 76 may be provided side by side in a projecting shape (protrusion) that extends to be long in one direction before and after a top portion of the other end portion 751b of the support portion 751 in the connection target terminals 75A, 75B, 75C, and 75D.

### Exemplary Embodiment 3

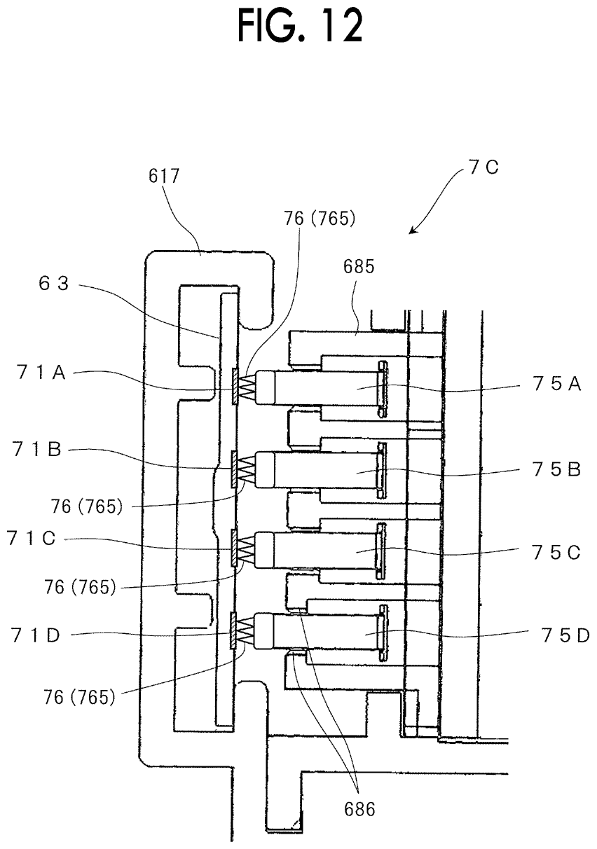

FIG. 12 illustrates a terminal connection structure 7C according to Exemplary Embodiment 3.

The terminal connection structure 7C according to Exemplary Embodiment 3 is a structure having the same configuration as that of the terminal connection structure 7 according to Exemplary Embodiment 1 except that a corrugated member is disposed instead of the coil spring 761 for the plural contact portions 76.

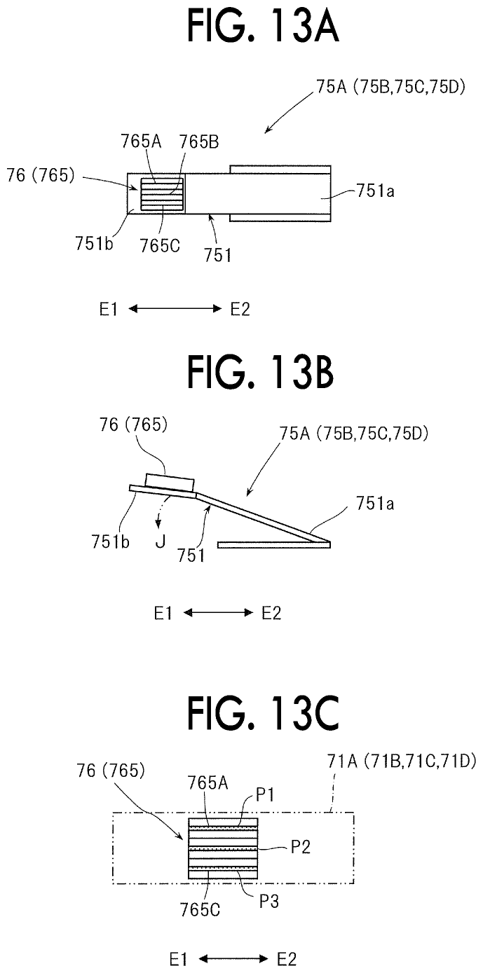

As illustrated in FIG. 12 or 13A to 13C, the terminal connection structure 7C is formed by disposing corrugated members 765 as the plural contact portions 76. As the corrugated member 765, a member that is bent in a zigzag shape so as to have plural (three in this example) mountain-fold portions and valley-fold portions between the mountain-fold portions or at both ends, and has conductivity at least on the surface thereof, is used. In addition, the conditions, such as the size, the number of bending or the like of the corrugated member 765, are set to any condition in accordance with the relationship between the terminals connected to each other, or the like.

In addition, as illustrated in FIG. 13A, the corrugated member 765 that forms the plural contact portions 76 are disposed such that any longitudinal direction of the three mountain-fold portions 765A, 765B, and 765C is in a state of facing in a direction substantially along the moving directions E1 and E2 when attaching and detaching the developer storage container 61. Accordingly, the three mountain-fold portions 765A, 765B, and 765C of the corrugated member 765 are in a state of being arranged in parallel at intervals from each other in a state of being oriented in the direction substantially along the moving directions E1 and E2 of the developer storage container 61.

Furthermore, as illustrated in FIG. 13B, the corrugated member 765 is disposed in the other end portion 751b that is in a state of being inclined in the support portion 751 of the connection target terminals 75A, 75B, 75C, and 75D.

In addition, in the image forming apparatus 1 using the terminal connection structure 7C, when the mounting of the developer storage container 61 is completed as described in Exemplary Embodiment 1, as illustrated in FIG. 12, the four connection terminals 71A, 71B, 71C, and 71D that are in the storage medium 63 in the accommodating section 617 of the developer storage container 61 are in a state of individually being in contact with and connected to the connection target terminals 75A, 75B, 75C, and 75D in the connector unit 68 that is in the replenishment drive device 67.

When the connection state at this time is viewed from the connection target terminals 75A, 75B, 75C, and 75D, as illustrated in FIG. 12 and other drawings, the connection target terminals 75A, 75B, 75C, and 75D are in a state where the plural contact portions 76 formed by disposing the corrugated member 765 respectively come into contact with and are connected to the connection terminals 71A, 71B, 71C, and 71D.

In other words, in the connection target terminals 75A, 75B, 75C, and 75D at this time, as illustrated in FIG. 12 or 13C, all or parts of the three mountain-fold portions 765A, 765B, and 765C in the longitudinal direction in the corrugated member 765 that forms the plural contact portions 76 respectively come into contact with the connection terminals 71A, 7B, 71C, and 71D.

In addition, the contact part of the corrugated member 765 at this time are contact points (contact portions) including parts P1, P2, and P3 made of three linear shapes that correspond to the three mountain-fold portions 765A, 765B, and 765C, as illustrated in FIG. 13C in an enlarged manner. In addition, the plural contact portions 76 at this time also come into contact with each of the four connection terminals 71A, 71B, 71C, and 71D at the three parts P1, P2, and P3 that are in a state of being arranged in a direction substantially orthogonal to the moving directions E1 and E2 when mounting the developer storage container 61.

In the terminal connection structure 7C used for connection, therefore, each of the four connection terminals 71A, 71B, 71C, and 71D in the storage medium 63 comes into contact with each of the connection target terminals 75A, 75B, 75C, and 75D at the plural contact portions 76 in the connector unit 68, similar to the case of the terminal connection structure 7 according to Exemplary Embodiment 1, so that abnormal contact is less likely to occur.

In addition, in the image forming apparatus 1 using the terminal connection structure 7C, communication of information between the developer storage container 61 and the control unit 15 is excellently secured when the developer storage container 61 is attached, similar to the case of the image forming apparatus 1 according to Exemplary Embodiment 1, so that communication failure is less likely to occur.

### Modification Example

The disclosure is not limited to the contents shown in Exemplary Embodiments 1 to 3, and can be variously modified without departing from the scope of each disclosure described in each claim. Therefore, the disclosure also includes modification examples as shown in the following.

In the terminal connection structures 7, 7B, and 7C in Exemplary Embodiments 1 to 3, the plural contact portions 76 may be provided on the four connection terminals 71A, 71B, 71C, and 71D in the storage medium 63.

In addition, the plural contact portions 76 can also be provided on the terminal side not having the intruding structure, for example, in a case where it is possible to give characteristics that can be elastically deformed. Furthermore, the plural contact portions 76 are not limited to a case of being provided on all of the connection terminals or the connection target terminals, and may be provided, for example, at some of the terminals where connection accuracy is relatively strongly required.

In addition, the terminal connection structures 7. 7B, and 7C are not limited to the use between the connection terminals 71 of the storage medium 63 in the developer storage container 61 shown in Exemplary Embodiments 1 to 3 and the connection target terminals 75 in the connector unit on the mounting section side. As another configuration example, for example, it is also possible to use the terminal connection structure between connection terminals, such as a storage medium or a feeding system, in the attaching and detaching unit having at least a photosensitive drum 21 or an attaching and detaching unit having other configuration components, and connection target terminals in the connector unit on the mounting section side of each attaching and detaching unit.

Furthermore, the terminal connection structures 7, 7B, and 7C may also be used in apparatuses other than the image forming apparatus. In particular, the terminal connection structure may also be used for high-accuracy connection between the connection terminal in the first device, which is detachably attached, and the connection target terminal in the second device to which the first device is attached.

In addition, the image forming apparatus using the terminal connection structure 7 may be of any suitable type, and the form, the type, the image forming method, and other features thereof are not particularly limited.

The foregoing description of the exemplary embodiments of the present invention been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A terminal connection structure between a first device to be detachably attached for use and a second device having a mounting section to which the first device is to be detachably attached, the terminal connection structure comprising:
a plurality of connection terminal provided in the first device; and
a plurality of connection target terminal that is provided in the second device and comes into contact with the connection terminal in an electrically conductive manner when the first device is attached to the mounting section,
one of the connection terminal and the connection target terminal having a structure including a plurality of contact portions to be in contact with the other,
wherein the plurality of contact portions are formed by a plurality of wire parts on the connection terminal or the connection target terminal arranged in parallel,
wherein the number of the plurality of connection terminals is equal to the number of the plurality of connection target terminals.

2. (canceled)

3. (canceled)

4. The connection structure according to claim 1, wherein
the plurality of wire parts are disposed so as to have longitudinal directions arranged in parallel along a direction in which the first device is moved for attachment and detachment.

5. (canceled)

6. The connection structure according to claim 1, wherein
one of the connection terminal and the connection target terminal is provided to form an intruding structure that is elastically deformable and displaceable so as to intrude to a position matching a position of the other when brought into contact with the other, and
the plurality of contact portions are provided in the connection terminal or connection target terminal having the intruding structure.

7. (canceled)

8. An image forming apparatus comprising:
an attachable and detachable unit that has a connection terminal and is to be detachably attached for use; and
an apparatus main body having: a mounting section to which the attachable and detachable unit is to be detachably attached; and a connection target terminal that comes into contact with the connection terminal in an electrically conductive manner when the attachable and detachable unit is attached to the mounting section,
the connection terminal and the connection target terminal forming the terminal connection structure according to claim 1.

9. The image forming apparatus according to claim 8, wherein
the plurality of contact portions are provided in the connection target terminal of the apparatus main body.
